(19) United States
(12) Patent Application Publication
(10) Pub. No.: US 2026/0326134 A1
(43) Pub. Date: Oct. 22, 2026

(54) COATING AGENT SUPPLY DEVICE AND ASSOCIATED OPERATING METHOD

(71) Applicant: Dürr Systems AG, Bietigheim-Bissingen (DE)

(72) Inventors: Anna Weißenberger, Besigheim (DE); Manfred Michelfelder, Steinheim (DE); Alexander Falheier, Ludwigsburg (DE)

(21) Appl. No.: 19/113,210

(22) PCT Filed: Feb. 1, 2024
(86) PCT No.: PCT/EP2024/052446

§ 371 Date: Mar. 19, 2025

(30) Foreign Application Priority Data
Feb. 6, 2023 (DE) 10 2023 102 825.1

(51) Int. Cl. B05B 12/14; B05B 15/55; B05B 15/58

(52) U.S. Cl. CPC B05B 12/1481; B05B 15/55; B05B 15/58

(57) ABSTRACT

A coating agent supply device for supplying an application station of a coating installation with a coating agent to be applied, in particular in a paint mixing room for supplying a pigging system in a paint booth of a painting installation for painting motor vehicle body components with the paint to be applied. The coating agent supply device comprises at least one coating agent storage container for providing the coating agent to be applied, a transfer point for transferring the coating agent to be applied to the application station, in particular to the pigging system in the paint booth of the paint system, and a line arrangement between the coating agent storage container and the transfer point. The line arrangement between the coating agent storage container and the transfer point comprises at least one piggable line.

### CROSS-REFERENCE TO RELATED APPLICATIONS

This application is a national stage of, and claims priority to, Patent Cooperation Treaty Application No. PCT/EP2024/052446, filed on Feb. 1, 2024, which application claims priority to German Application No. DE 10 2023 102 825.1, filed on Feb. 6, 2023, which applications are hereby incorporated herein by reference in their entireties.

### TECHNICAL FIELD

The disclosure relates to a coating agent supply device for supplying an application station (e.g. painting robot) of a coating installation (e.g. painting installation) with a coating agent (e.g. paint) to be applied. In some embodiments of the disclosure, the coating agent supply device is located in a paint mixing chamber for supplying a pigging system in a paint booth of a painting installation for painting motor vehicle body components with the paint to be applied. The disclosure also relates to an associated operating method.

### BACKGROUND

FIG. 1 shows a schematic representation of a conventional painting installation for painting motor vehicle body components 1. The motor vehicle body components 1 to be painted are conveyed along a painting line through a painting booth in which four painting robots 2-5 are arranged on opposite sides of the painting line, each of which carries a rotary atomizer as an application device, although other types of application devices (e.g. print heads) can also be used as an alternative. A pig target module 6-9 is located on each of the individual painting robots 2-5, whereby the individual pig target modules 6-9 are connected to a pig source module 14 via piggable coating agent lines 10-13. The pig source module 14 is located at a transfer point 15 of a coating agent supply device, which is only shown schematically here and provides the coating to be applied. For this purpose, the coating agent supply device has a valve arrangement 16 at the transfer point 15, which is connected to a coating agent storage container 18 (“delivery container”) via a non-piggable coating agent line 17. For the sake of simplicity, only the coating agent storage container 18 is shown as the only coating agent storage container. In practice, however, up to four coating agent storage containers 18 can be provided, which are connected to the transfer point 15 via a color changer.

FIG. 2 also shows a schematic representation of such a conventional coating installation, so that reference is made to the above description in order to avoid repetition, whereby the same reference signs are used for corresponding details. Here, only three piggable coating agent lines 10-12 emanate from the transfer point 15, whereas in FIG. 1 four piggable coating agent lines 10-13 emanate from the transfer point 15. Furthermore, it can be seen from this drawing that the coating agent storage container 18 has a coating agent pump 19 in order to circulate the coating to be applied from the coating agent storage container 18 in a pump circuit, the pump circuit having a supply line 20 from the coating agent pump 19 to the transfer point 15 and a return line 21 from the transfer point 15 to the coating agent storage container 18. The pump circuit with the supply line 20 and the return line 21 can also not be pigged.

With regard to the technical background of the disclosure, reference should also be made to DE 100 06 310 A1, DE 10 2018 109 344 A1, DE 103 46 601 A1 and EP 1 319 441 A2.

### BRIEF DESCRIPTION OF THE DRAWINGS

FIG. 1 shows a schematic representation of the conventional painting installation described above for painting vehicle body components.

FIG. 2 shows a modification of the conventional painting installation shown in FIG. 1.

FIG. 3 shows a modification of the painting installation shown in FIG. 1 according to the disclosed technology.

FIG. 4 shows a modification of the painting installation shown in FIG. 2 according to the disclosed technology.

FIG. 5 shows a perspective view of a pigging station of the painting installation according to the disclosed technology as shown in FIGS. 3 and 4.

FIG. 6 shows a sectional view of a pig source module of the painting installation according to the disclosed technology.

FIG. 7 shows a top view of a distribution station of the painting installation according to the disclosed technology.

FIG. 8 shows a single view of a plate-shaped distribution module of the distribution station from FIG. 7.

FIG. 9 shows the painting installation according to FIG. 4 in a normal state.

FIG. 10 shows the painting installation as shown in FIG. 4 during the application of a coating.

FIG. 11 shows the painting installation according to FIG. 4, where the pressurizing is completed and material circulation takes place.

FIG. 12 shows the paint spraying system from FIG. 12 when paint is being pressed back into a coating agent storage container.

FIG. 13 shows the painting installation from FIG. 4 during a rinsing process.

Finally, FIG. 14 shows a flow chart to illustrate the operating method according to the disclosed technology.

### DETAILED DESCRIPTION OF THE DRAWINGS

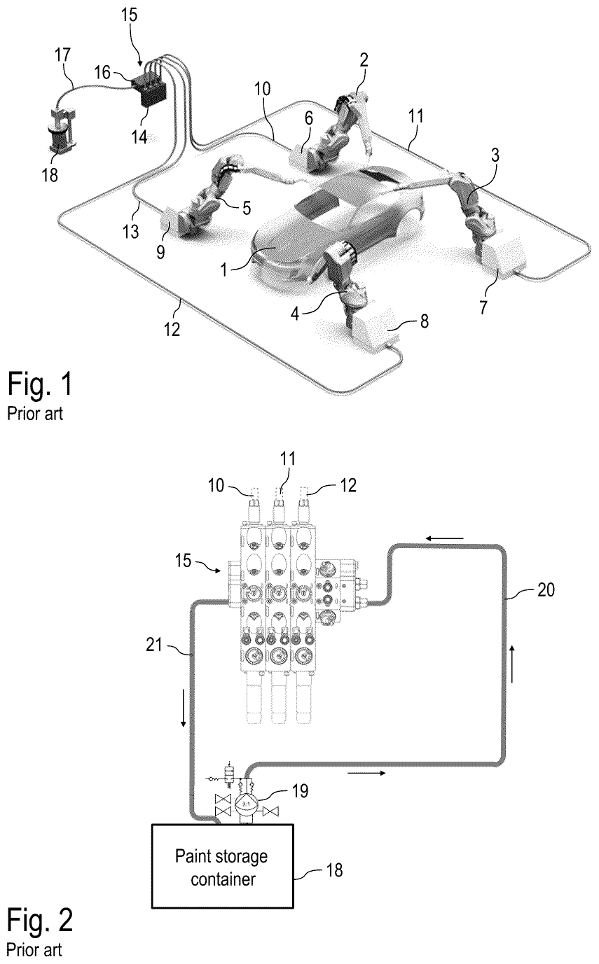

The concept of a conventional coating agent supply device for a painting installation described above and shown schematically in FIGS. 1 and 2 has various disadvantages, which are described below.

One disadvantage is that up to now only four of the coating agent storage containers 18 could be connected to the transfer point 15, so that only four different colors could be applied. If, on the other hand, a different color is to be applied, it is necessary to replace one of the coating agent storage containers 18 with another with the desired color. When replacing one of the coating agent storage containers 18 in this way, it is necessary to remove paint residues from the entire pump circuit with the supply line 20 and the return line 21, which requires a rinsing process. This leads to a high consumption of rinsing agent and correspondingly high disposal costs for the disposal of the paint and rinsing agent residues. In addition, such a color change by replacing one of the coating agent storage containers 18 is very time-consuming.

A further disadvantage is that the paint must circulate continuously in the pump circuit in order to prevent paint from settling in the supply line 20 or the return line 21. This permanent paint circulation is associated with an undesirable shear stress on the paint. Another problem with the known coating agent supply device is therefore the shear stress on the paint, which has to circulate even when no application is taking place.

The disclosed technology is therefore based on the task of creating a correspondingly improved coating agent supply device and an associated operating method for such a coating agent supply device.

This task is solved by a coating agent supply device according to the disclosed technology and/or by a corresponding operating method.

The coating agent supply device according to the disclosed technology can be located in a paint mixing chamber of a painting installation for painting motor vehicle body components and provides the paint to be applied at a transfer point. However, the disclosure is not limited to paints with regard to the coating agent to be applied, but can also be realized with other types of coating agents. Furthermore, the disclosure is also not limited to motor vehicle body components with regard to the components to be coated, but can also be realized with other types of coating installations that coat other types of components.

The coating agent to be applied is taken from a coating agent storage container (“delivery container”) in the coating agent supply device, which usually has a large capacity that is sufficient for coating numerous components.

A line arrangement is located between the coating agent storage container and the transfer point in order to guide the coating agent from the coating agent storage container to the transfer point.

In the coating agent supply device described at the beginning, this line arrangement between the coating agent storage container and the transfer point is not piggable, which is associated with the disadvantages described at the beginning. The disclosure therefore provides that the line arrangement between the coating agent storage container and the transfer point contains at least one piggable line.

In some embodiments of the disclosure, the coating agent supply device has a plurality of coating agent storage containers to provide different coating agents. For example, each coating agent storage container may contain paint of a particular color. The design of the coating agent supply device according to the disclosure, which is described in more detail below, makes it possible for more than four different coating agent storage containers to be provided. For example, 15 different coating agent storage containers can be provided in order to provide a correspondingly large number of different colored paints without having to replace one of the coating agent storage containers.

The individual coating agent storage containers can each be connected to a pig line system. The individual pig line systems each contain a pigging station with a pig source module and a pig target module as well as a piggable line between the pig source module and the pig module. Such pig line systems are known per se from the prior art and therefore need not be described in detail. However, such pig line systems have not yet been used in a coating agent supply device to connect the coating agent storage containers with the transfer point.

In some embodiments of the disclosure, each of the coating agent storage containers is assigned a pig line system. However, the disclosure is also directed to a coating agent supply device in which a separate pig line system is provided for only some of the coating agent storage containers.

In some embodiments of the disclosure, the pig source module and the pig target module are each in the form of a plate and mechanically firmly connected to one another, with the pig source module and the pig target module lying plane-parallel to one another. The pig source module and the pig target module are therefore both located in the pigging station and thus approximately in the same place, which enables material circulation, as will be described in detail.

The piggable lines can be very long, as coating agent residues can be pigged back into the respective coating agent storage container (“reflow”) during breaks in application or when changing colors, thus avoiding the disturbing losses of rinsing agent and paint residues described at the beginning. This makes it possible for the piggable lines to have a length of more than 1 m, 2 m, 4 m, 10 m, 20 m, 50 m, 100 m or even more than 150 m. The greater line length between the transfer point and the coating agent storage containers made possible by the disclosure in turn enables greater flexibility in the structural design of the coating agent supply device.

The connection between the individual coating agent storage containers and the associated pig line systems can be made by a pump circuit in each case. For this purpose, a circulation line is provided in the circuit, which starts from the respective coating agent storage container, leads to the associated pigging station and returns to the respective coating agent storage container, whereby in some embodiments this circulation line is not piggable. The circulation line thus comprises a supply line from the coating agent storage container to the pigging station and a return line from the pigging station to the coating agent storage container.

In addition, the individual pump circuits can contain a circulation pump, which takes the coating agent from the respective coating agent storage container and circulates it in the respective pump circuit. The circulation pump therefore takes the respective coating agent from the respective coating agent storage container and conveys it through the supply line to the pigging station.

In addition, the individual pump circuits can each contain a return flow regulator, which is arranged in the pump circuit downstream of the respective pigging station in the return flow line and regulates the coating agent pressure at the associated pigging station. Such a return flow regulator is particularly useful if several distribution stations are arranged in the paint mixing room circuit described below.

In addition, the individual pump circuits can each contain a controllable valve, which is arranged in the respective pump circuit upstream of the pigging station in the supply line and directs the coating agent flow either to the respective pigging station or into a return line. This controllable valve can be a twin valve. On the one hand, such a twin valve enables the discarding of residual rinsing agent from the circulation pump. On the other hand, the twin valve also enables bubble-free filling of the pig source module.

In some embodiments of the disclosure, the individual pig target modules are not only connected to the associated pig source module by the piggable line, but also by an additional connecting line, which is not piggable in some embodiments of the disclosure.

On the one hand, this connecting line enables material circulation through the piggable line and the connecting line, whereby material circulation is also possible in a large circuit that includes the pump circuit and the pig line system (paint mixing room circuit). The material is then circulated from the coating agent storage container via the supply line to the pig source module, through the piggable line to the pig target module, via the connecting line back to the pig source module and then via the return line back to the coating agent storage container.

On the other hand, the connecting line between the pig target module and the pig source module also enables unapplied coating agent to be returned from the piggable line via the pig target module through the connecting line and the pig source module and the pump circuit back into the respective coating agent storage tank (“reflow”).

It should also be mentioned that the individual pigging stations can each contain a controllable valve arrangement, whereby this valve arrangement, depending on its control, enables one of the following flow sequences in the coating agent supply device:
During pressurizing: The coating agent flows from the coating agent storage container via the circulation line of the pump circuit to the pig source module and there into the piggable line in order to fill the piggable line with the coating agent.
During material circulation: The pump circuit and the associated pig line system (paint mixing room circuit) together form a large circuit with material circulation from the coating agent storage tank, via the pump circuit to the pig source module, through the piggable line to the pig target module, through the connecting line to the pig source module and through the pump circuit back to the coating agent storage tank.
During material return: The coating agent remaining in the piggable line is pressed back into the coating agent storage container via the pig target module, the connecting line and the pump circuit.

During rinsing: Rinsing agent and/or pulsed air is introduced at the pig source module and flows via the piggable line to the pig target module and from there via the connecting line to the pig source module and further into the circulation line and finally into a return line.

It has already been explained above that the individual coating agent storage containers are each assigned a pig line system in order to guide the coating agent to be applied to the transfer point. The individual pig line systems can be connected to a common distribution station. The common distribution station is therefore connected to the piggable lines on the supply side in order to take the coating agent from the piggable lines. On the application side, however, the distribution station is connected to the transfer point via at least one central channel. In this case, the common distribution station contains a controllable valve unit to connect the piggable lines to the at least one central channel on the application side in a selectively controllable manner.

It should be mentioned here that the at least one central channel between the distribution station and the transfer point cannot be pigged in some embodiments.

It should also be mentioned that several central channels can also be provided between the distribution station and the transfer point, such as two, three or four central channels.

However, the central channels can have a relatively short cable length, which is less than 1 m.

The distribution station can contain a distribution module for each of the pig line systems in order to take the coating agent from the associated piggable line. The individual distribution modules are each plate-shaped and identical in construction, which enables a modular and expandable design of the distribution station. The individual plate-shaped distribution modules are then aligned parallel to each other and arranged in a row next to each other. In addition, the distribution modules are mechanically connected to each other, in particular by a screw connection. Depending on the number of coating agent storage containers to be connected and the correspondingly large number of pig line systems to be connected, a correspondingly large number of distribution modules can then be integrated into the distribution station.

It should be mentioned here that the distribution station for the individual piggable lines has a passage channel for each pig, which is passable for a pig, so that the piggable lines each pass through the distribution station. In the modular design of the distribution station described above with several distribution modules, such a passage channel is provided in each of the distribution modules.

In general, it should be noted that the common distribution station has a number n of inputs for the piggable lines on the supply side. In addition, on the application side, the common distribution station has a number m of outputs for the central channels to the transfer point. The number n of inputs for the piggable lines is greater than the number m of outputs for the central channels. For example, the number m of outputs for the central channels can be two, three or four, while the number n of inputs for the piggable lines is greater than four.

Furthermore, in some embodiments of the disclosure, it is provided that at least one pig sensor is arranged on the individual piggable lines in order to detect a pig in the piggable line. Such pig sensors are known per se from the prior art and therefore need not be described in more detail. In some embodiments, the pig sensor is arranged at the pigging station, in particular at a distance from the pigging station of less than 50 cm, 20 cm, 10 cm or 5 cm. For example, a double pig sensor can be used, which can monitor both the pig supply line and the pig return line. On the one hand, the double pig sensor can therefore detect whether a pig enters the pig source module or leaves the pig source module. On the other hand, the double pig sensor can also detect whether a pig moves into the pig target module or leaves the pig target module.

It has already been mentioned at the beginning that the at least one coating agent storage container (“delivery container”) can be replaceable and generally has a large capacity that is sufficient for coating numerous components. For example, this capacity can be at least 10 I, 50 I, 100 I, 250 I or 500 I.

Within the scope of the disclosure, the number of coating agent storage containers can be greater than two, three, four, five or even greater than ten. Due to the relatively large number of simultaneously connected coating agent storage containers, many different coating agents can be applied without having to replace a coating agent storage container, thus avoiding the disturbing color change losses described at the beginning.

The coating agent supply device according to the disclosure, which provides the respective coating agent at the transfer point, has been described above. However, the disclosure also claims protection for a coating installation which additionally has an application station which is connected to the transfer point of the coating agent supply device and has at least one application device (e.g. rotary atomizer) in order to apply the coating agent provided at the transfer point.

The transfer point can therefore have a pig source module on the application side, which is connected to a pig target module on an application device via at least one piggable line. The piggable line between the transfer point and the application device can have a relatively long line length, which can be in the range of 30 m to 200 m, for example.

It should also be mentioned that the individual pig target modules of the application station can each be connected to the pig source module at the transfer point via several parallel piggable lines. This facilitates the application of different coating agents.

In general, it should also be mentioned that the application device can be an atomizer (e.g. rotary atomizer). However, other application devices can also be used within the scope of the disclosure, such as so-called print heads.

However, the application device can be guided by an application robot, whereby several such application robots can be provided in an application station.

Finally, it should be mentioned that the disclosure also claims protection for a corresponding operating method which performs at least one of the following steps in at least one of the pig line systems of the coating agent supply device:
Filling the piggable line of the coating agent supply device, the coating agent being pumped from the coating agent storage container through the circulation line of the pump circuit to the pig source module and flowing there into the piggable line, the pig being conveyed together with the coating agent in the piggable line from the pig source module to the pig target module.
Circulation of the coating agent in the large circuit formed by the pump circuit and the associated pig line system located in the paint mixing room, whereby the coating agent flows from the coating agent storage container via the circulation line of the pump circuit to the pig source module, through the piggable line to the pig target module, through the connection line to the pig source module and through the circulation line back to the coating agent storage container.
Stopping the circulation of the coating agent in the large circuit before coating begins.
Taking of the coating agent from the piggable line at the distribution station.
Transfer of the extracted coating agent from the distribution station through the central channel to the transfer point.
Transfer of the extracted coating agent from the transfer point to the application device of the application station, via a pigging system between the transfer point and the application station or directly and without a pigging system from the transfer point to the application station.
Application of the extracted coating agent by the application device.
Returning the unapplied coating agent from the piggable line of the coating agent supply device via the pig source module and the circulation line of the pump circuit back into the coating agent storage container.
Rinsing the piggable line, the pig source module and/or the pig target module with pulsed air and/or rinsing agent.

It has already been mentioned above that it is possible within the scope of the disclosure to return coating agent to the coating agent storage containers. For this purpose, the following steps are carried out within the scope of the disclosure:
Introduction of the compressed air at the pig target module into the piggable line, whereby the compressed air pushes the pig and the coating agent column located in front of the pig in the piggable line to the pig source module.
Pushing back the coating agent column at the pig source module from the piggable line into the circulation line of the pump circuit.
Pushing back the coating agent column from the circulation line of the pump circuit into the coating agent storage container.

In addition, it has already been mentioned above that the coating agent supply device can be played. The following steps are carried out for this purpose:
Introduction of rinsing agent and/or pulsed air at the pig source module into the piggable line of the coating agent supply device.
Passing the rinsing agent and/or the pulsed air from the pig source module through the piggable line to the pig target module.
Passing the rinsing agent and/or the pulsed air on the pig target module through the connecting line to the pig source module.
   Passing on the rinsing agent and/or the pulsed air at the pig source module into the circulation line of the pump circuit.

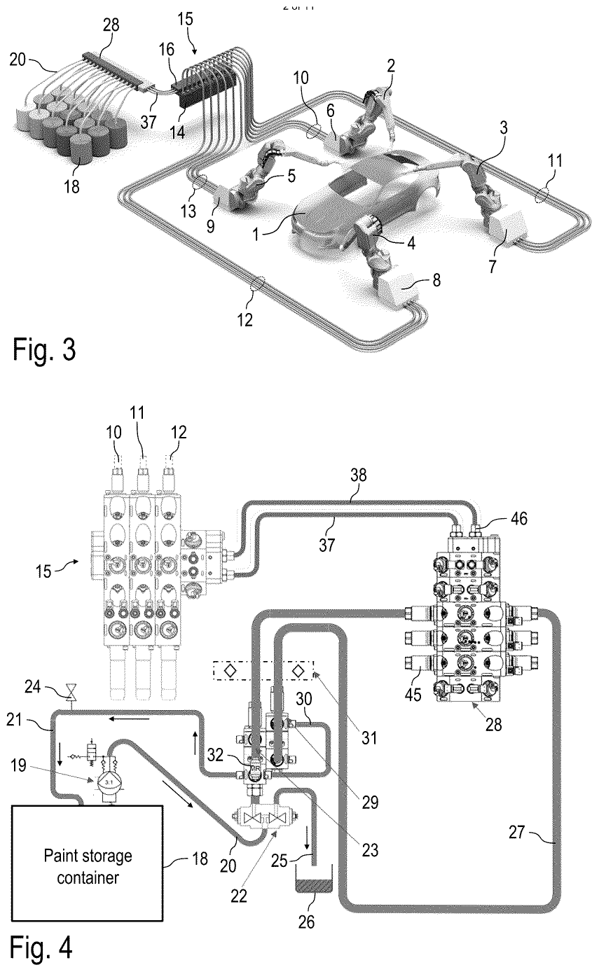

In the following, the embodiment of a coating agent supply device according to the disclosure is described, as shown in FIG. 3 and in a slightly modified form in FIG. 4. The embodiment according to the disclosure corresponds in part to the conventional coating agent supply device as shown in FIGS. 1 and 2. To avoid repetition, reference is therefore made to the above description, with the same reference signs being used for corresponding details.

A special feature of this embodiment is that three parallel piggable coating agent lines 10-13 each run between the pig target modules 6-9 and the pig source module 14 at the transfer point 15, so that three different coatings can be provided at the pig target modules 6-9.

Another special feature of this embodiment is the design and function of the coating agent supply device upstream of the transfer point 15.

Thus, the paint to be applied is provided by a total of 15 coating agent storage containers 18, whereby a larger or smaller number of coating agent storage containers 18 is also possible.

The coating agent storage containers 18 each have a coating agent pump 19, which takes the coating from the respective coating agent storage container 18 and conveys it to a pig source module 23 via a non-piggable supply line 20 and a twin valve 22. A non-piggable return line 21 leads from the pig source module 23 back to the coating agent storage container 18. The supply line 20 and the return line 21 therefore form a pump circuit that cannot be pigged and enables material circulation in the pump circuit.

To avoid misunderstandings, it should be mentioned that each of the 15 coating agent storage containers 18 is assigned a pump circuit, each of which leads to a pig source module 23. To simplify matters, however, only a single pump circuit is shown in each of the drawings.

In addition, a return flow regulator 24 is arranged in the return line 21 of the pump circuit, which regulates the paint pressure at the pig source module 23 to a predetermined value.

The twin valve 22 can either direct the paint supplied via the supply line 20 to the pig source module 23 or via a return line 25 to a return line 26.

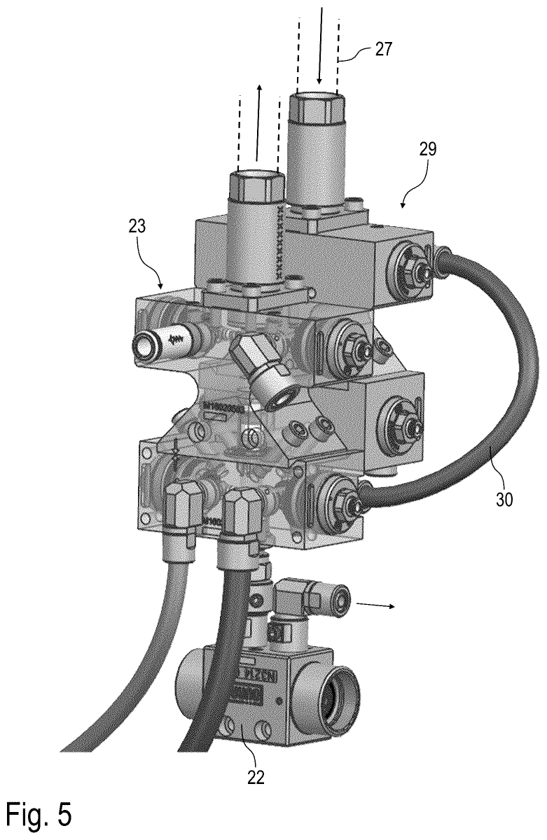

A piggable coating agent line 27 leads from the pig source module 23 through a distribution station 28 to a pig target module 29, the pig target module 29 being mechanically connected to the pig source module 23, as can be seen in FIG. 5.

A connecting line 30 also goes from the pig target module 29 to the pig source module 23, whereby the connecting line 30 is not piggable. The piggable coating agent line 27 between the pig source module 23 and the pig target module 29 thus forms a paint mixing chamber circuit together with the connecting line 30.

This enables paint circulation, which includes both the pump circuit and the paint mixing chamber circuit. The paint is then taken from the coating agent storage container 18 and flows via the supply line 20 and the twin valve 22 into the pig source module 23. From there, the paint then flows further via the piggable coating agent line 27 through the distribution station 28 to the pig target module 29. From the pig target module 29, the paint then flows through the connecting line 30 to the pig source module 23 and from there via the return line 21 back to the coating agent storage container 18.

In addition, a double pig sensor 30 is provided, which can detect when a pig passes the double pig sensor 30 in the piggable coating agent line 27. On the one hand, the double pig sensor 30 can thus detect whether a pig 32 enters the pig source module 23 or leaves the pig source module 23. On the other hand, the double pig sensor 32 can also detect whether a pig 32 moves into the pig target module 29 or leaves the pig target module 29.

To avoid misunderstandings, it should be mentioned that each of the coating agent storage containers 18 is not only assigned a pump circuit, but also a paint mixing chamber circuit. However, only one paint mixing chamber circuit is shown in the drawings for simplification.

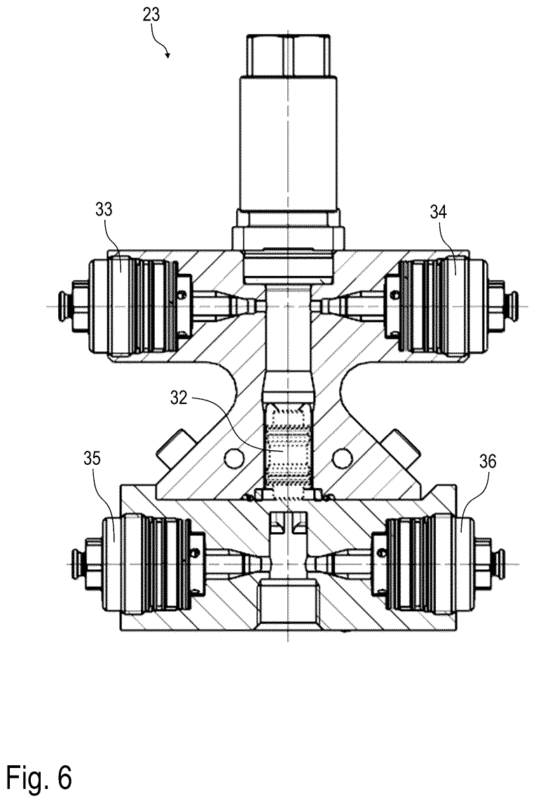

FIG. 6 shows a sectional view of the pig source module 23, whereby the pig target module 29 is identical in construction, so that a separate description of the pig target module 29 can be dispensed with.

In the drawing, a pig 32 is shown in the pig source module 23. The pig 32 can then be moved by compressed air drive from the pig source module 23 through the piggable coating agent line 27 to the pig target module 29.

To control this pig movement and to control the paint flow, the pig source module 23 has several valves 33-36. The mode of operation of the pig source module 23 is basically known from the prior art and therefore need not be described in detail.

FIG. 4 also shows that the distribution station 28 is connected to the transfer point 15 via two central channels 37, 38. The central channels 37, 38 cannot be pigged.

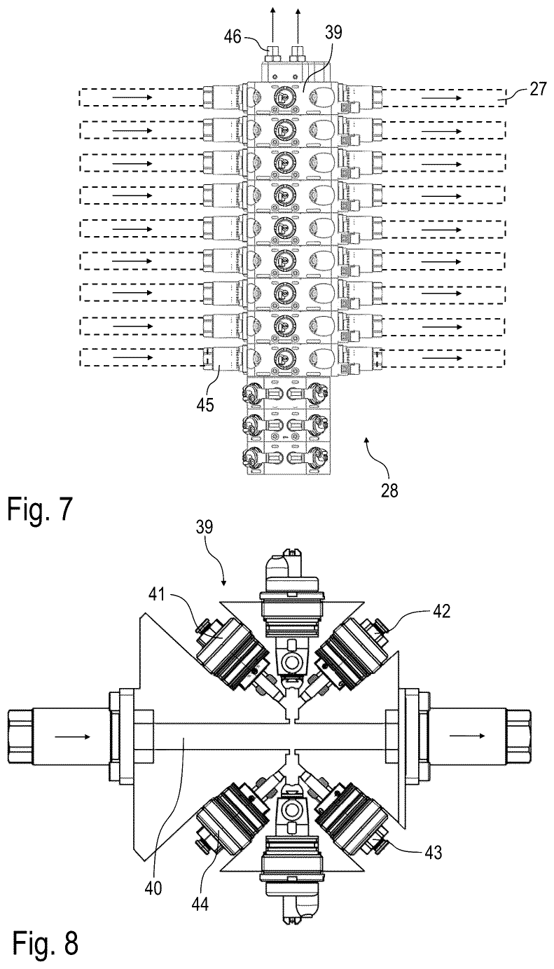

FIG. 7 shows that the distribution station 28 has numerous plate-shaped distribution modules 39, whereby the number of distribution modules 39 can be changed due to the modular structure of the distribution station 28. In FIG. 7, the distribution station 28 has nine of the distribution modules 39. In FIG. 4, on the other hand, the distribution station 28 has only three of the distribution modules 39.

FIG. 8 shows a sectional view through the distribution module 39, from which it can be seen that a through-channel 40 passes through the distribution module 39, whereby the through-channel 40 can be passed by the pig 32.

In addition, the distribution module 39 has several valves 41-44 to control the extraction of material from the through-channel 40.

The distribution station 28 has a certain number of input connections 45 on the supply side in order to be able to connect one of the piggable coating agent lines 27 in each case. In addition, the distribution station 28 has a certain number of output connections 46 on the application side in order to be able to connect one of the central channels 37, 38 in each case. In FIG. 7, the distribution station 28 has nine input connections 45 and two of the output connections 46. In FIG. 4, on the other hand, the distribution station 28 has only three input connections 45 and two output connections 46.

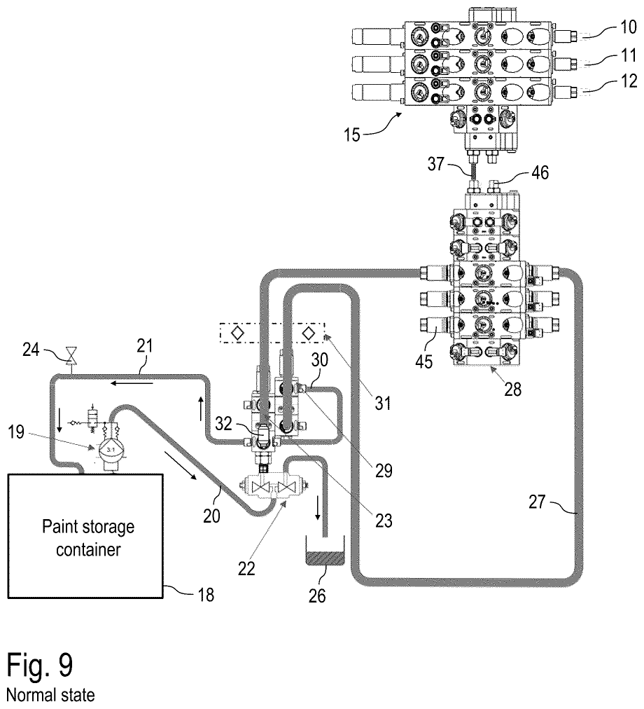

The normal state of the embodiment shown in FIG. 9 is now described below. In this normal state, the pig 32 is located in the pig source module 23.

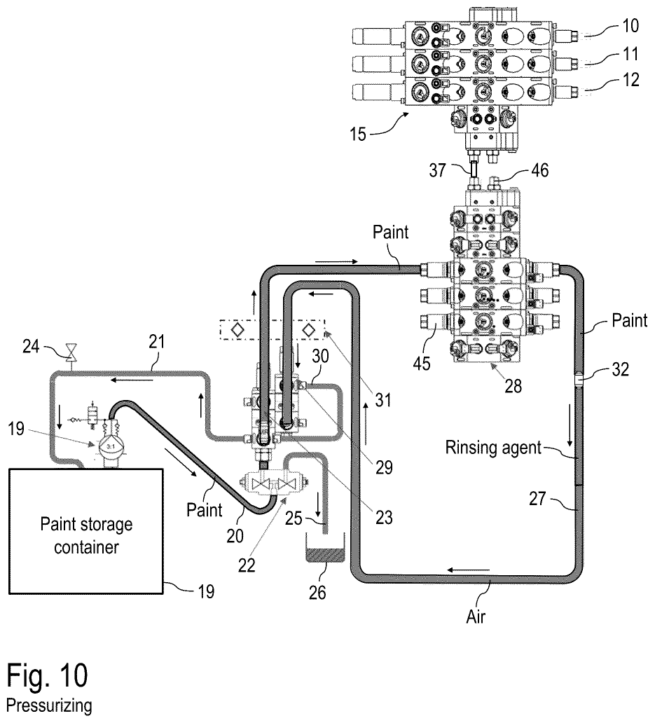

FIG. 10 now shows the pressurizing with paint. The coating agent pump 19 then delivers the coating from the respective coating agent storage container 18 via the supply line 20 to the pig source module 23 into the piggable coating agent line 27, whereby the pig 32 is moved towards the pig target module 29. Rinsing agent is located upstream of the pig 32 in order to rinse the piggable coating agent line 27.

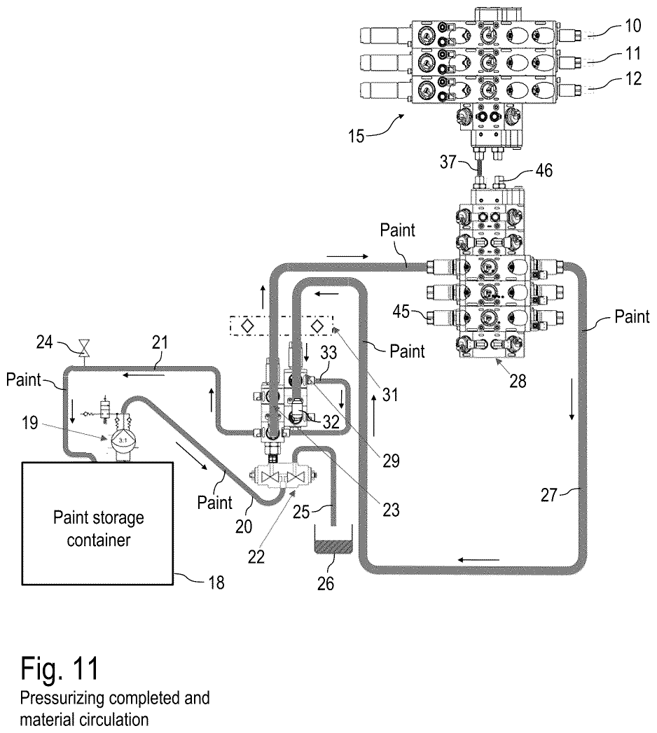

FIG. 11 now shows the state when pressurizing is completed and material circulation takes place. In this operating state, the coating agent pump 19 conveys the respective coating from the coating agent storage container 18 through the supply line 20 to the pig source module 23. The coating then flows from the pig source module 23 via the piggable coating agent line 27 to the pig target module 29. From there, the paint then flows through the connecting line 30 to the pig source module 23 and from there via the return line 21 back into the coating agent storage container 18. This material circulation therefore includes both the pump circuit and the paint mixing chamber circuit.

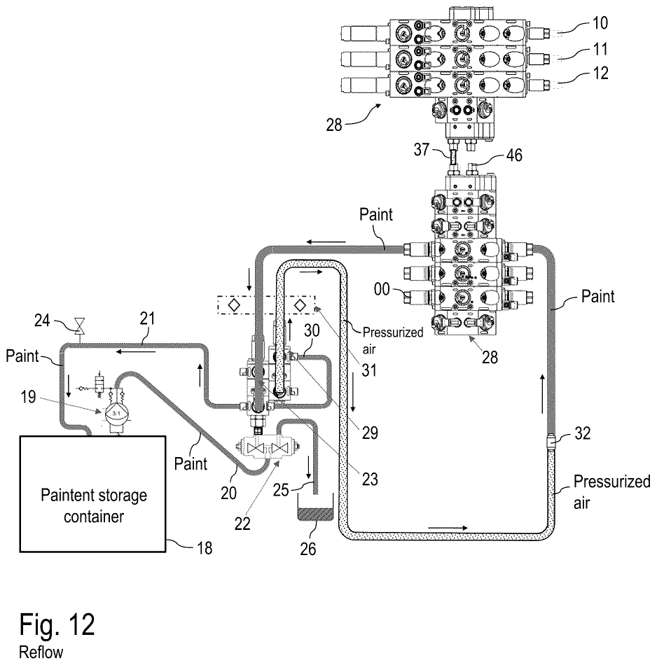

FIG. 12 shows a reflow operation in which paint is pressed back into the coating agent storage container 18. Here, the pig 32 is moved back to the pig source module 23 by compressed air in the piggable coating agent line 27. In doing so, the pig 32 pushes back the paint column located in the piggable coating agent line 27. The paint in the piggable coating agent line 27 is then pressed out of the pig source module 23 via the return line 21 back into the coating agent storage container 18.

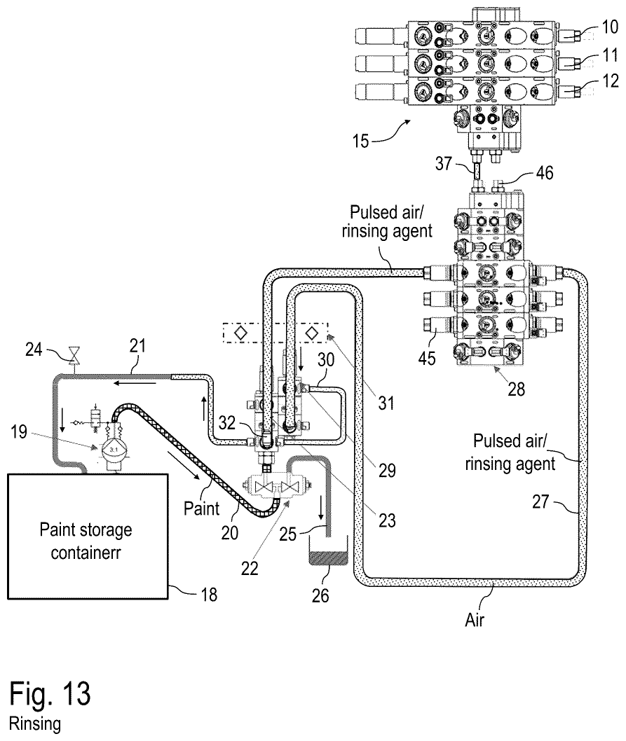

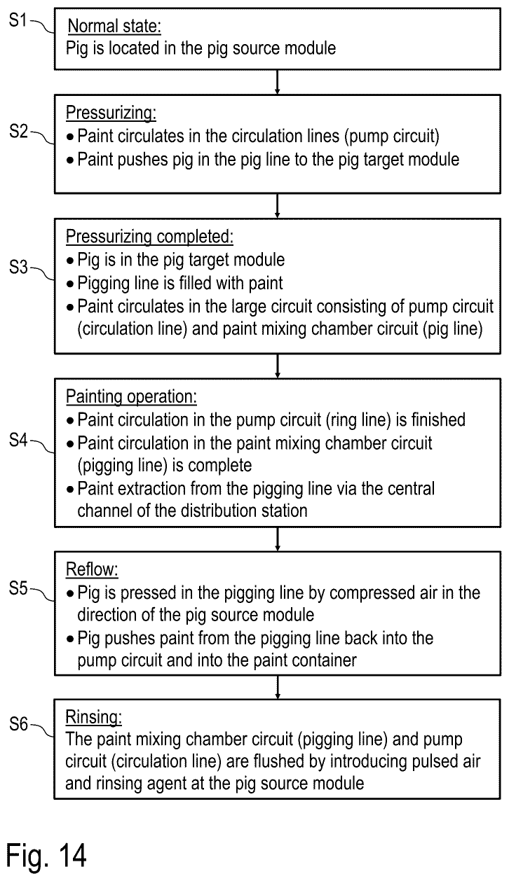

Finally, FIG. 13 shows a rinsing process. Pulsed air and rinsing agent are introduced into the piggable coating agent line 27 at the pig source module 23 in order to clean it.

Finally, FIG. 14 shows a flow chart to illustrate the operating method according to the disclosure. In a step S1, the painting installation is first brought into the normal state, which is shown in FIG. 9 and was described above.

In the next step S2, the paint is then pressed on, as shown in FIG. 10 and described above.

The next step S3 then shows the state shown in FIG. 11, in which pressurizing is completed and material circulation takes place.

The actual painting operation then takes place in step S4. The distribution station 28 takes the desired paint from the piggable coating agent line 27 and forwards it to the painting robots 2-5 via the transfer point 15.

In the next step S5, reflow operation takes place, as shown in FIG. 12 and described above.

Finally, in step S6, a rinsing operation takes place, as shown in FIG. 13 and described above.

### Advantages of the Disclosure

The disclosure makes it possible to connect a large number of paint systems to the transfer point to the pigging system of the painting installation, i.e. more than four coating agent storage containers (“delivery containers”) with different paints can be provided.
The disclosure enables significantly faster paint availability when more than four different paints are applied, as the different paints can be stored in the paint mixing chamber circuit without the need to replace one of the coating agent storage containers (“delivery containers”).
Even when applying more than four different colors of paint, the otherwise necessary rinsing and pressurizing processes are no longer necessary, as there is no need to replace the coating agent storage container (“delivery container”).
The disclosure makes it possible to reduce conventional ring line systems so that no additional paint waste is produced due to the shear stress on the paint in the case of rarely required paints (“low runner”).
Existing pigging systems can be used more efficiently.
The disclosure enables higher system availability, i.e. the necessary interruptions to application operation are shortened.
Reduction of paint losses by minimizing the need to replace the coating agent storage containers (“delivery containers”). This means that it is no longer necessary to replace the coating storage containers when changing colors, but only when the coating storage containers are empty.
Reduction of the paint application quantity compared to conventional ring line systems (smaller filling quantity than with ring line)
Automatic provision of paint material at the required time (without manual intervention).

1.-21. (canceled)

22. A coating agent supply device for supplying an application station of a coating installation with a coating agent to be applied, comprising:
a) at least one coating agent storage container for providing the coating agent to be applied,
b) a transfer point for transferring the coating agent to be applied to the application station, and
c) a line arrangement between the coating agent storage container and the transfer point,
d) wherein the line arrangement contains at least one piggable line between the coating agent storage container and the transfer point.

23. The coating agent supply device according to claim 22, wherein
a) several coating agent storage containers are provided in order to provide different coating agents,
b) the individual coating agent storage containers are each connected to a pig line system, and
c) the individual pig line systems each comprise the following components:
c1) a pigging station with a pig source module and a pig target module and
c2) a piggable line between the pig source module and the pig target module.

24. The coating agent supply device according to claim 23, wherein the piggable lines each have a line length which is greater than 4 m.

25. The coating agent supply device according to claim 23, wherein the pig source module and the pig target module in the pigging station are firmly connected to one another.

26. The coating agent supply device according to claim 25, wherein the pig source module and the pig target module are plate-shaped and lie plane-parallel to one another.

27. The coating agent supply device according to claim 23, wherein
a) the connection between the individual coating agent storage containers and the associated pig line systems is made by one pump circuit each,
b) the individual pump circuits each contain the following components:
b1) a circulation line in circulation, which starts from the respective coating agent storage container, leads to the associated pigging station and leads back to the respective coating agent storage container, wherein the circulation line is not piggable, wherein the circulation line comprises a supply line and a return line,
b2) a circulation pump, which takes the coating agent from the respective coating agent storage container and circulates it in the respective pump circuit, and
b3) a return flow regulator, which is arranged in the pump circuit downstream of the respective pigging station and regulates the coating agent pressure at the associated pigging station, and
b4) a controllable valve, which is arranged in the pump circuit upstream of the respective pigging station in the supply line and selectively directs the coating agent flow to the respective pigging station or into a return line.

28. The coating agent supply device according to claim 23, wherein in at least one of the pig line systems the pig target module is connected to the pig source module by a connecting line,
a) to return unapplied coating agent from the piggable line via the pig target module through the connecting line and the pig source module through the pump circuit into the respective coating agent storage container, and
b) to enable material circulation in a large circuit comprising the pump circuit and the pig line system, starting from the coating agent storage container via the pump circuit to the pig source module, through the piggable line to the pig target module, via the connecting line to the pig source module and from there via the pump circuit back to the coating agent storage container.

29. The coating agent supply device according to claim 28, wherein the connecting line between the pig target module and the pig source module cannot be pigged.

30. The coating agent supply device according to claim 23, wherein
a) the individual pigging stations each contain a controllable valve arrangement,
b) the valve arrangement, depending on its actuation, selectively enables one of the following flow sequences in the coating agent supply device:
b1) Pressurizing: The coating agent flows from the coating agent storage container via the circulation line of the pump circuit to the pig source module and there into the piggable line in order to fill the piggable line with the coating agent,
b2) Material circulation: The pump circuit and the associated pig line system together form a large circuit with material circulation from the coating agent storage container, via the pump circuit to the pig source module, through the piggable line to the pig target module, through the connecting line to the pig source module and through the pump circuit back to the coating agent storage container,
b3) Material return: The coating agent remaining in the piggable line is pressed back into the coating agent storage container via the pig target module, the connecting line and the pump circuit,
b4) Rinsing: Rinsing agent and/or pulsed air is introduced at the pig source module and flows via the piggable line to the pig target module and from there via the connecting line to the pig source module and further into the circulation line and finally into a return line.

31. The coating agent supply device according to claim 23, wherein
a) the coating agent supply device comprises a common distribution station for the pig line systems,
b) distribution station is connected on the supply side to the piggable lines in order to take the coating agent from the piggable lines,
c) the distribution station is connected on the application side to the transfer point via at least one central channel, and
d) the common distribution station comprises a controllable valve unit in order to connect the piggable lines to the at least one central channel on the application side in a selectively controllable manner.

32. The coating agent supply device according to claim 31, wherein
a) the at least one central channel between the distribution station and the transfer point is not piggable, and
b) the distribution station is connected to the transfer point by at least one central channel, and
c) the at least one central channel has a line length which is greater than 25 cm.

33. The coating agent supply device according to claim 31, wherein
a) the distribution station comprises a plurality of distribution modules,
b) each of the pig line systems is assigned one of the distribution modules in order to take the coating agent from the associated piggable line,
c) the individual distribution modules are each plate-shaped,
d) the distribution modules are aligned parallel to one another and arranged in a row next to one another,
e) the distribution modules are connected to one another, and
f) the distribution modules are identical in construction.

34. The coating agent supply device according to claim 31, wherein the distribution station for the individual piggable lines each has a passage channel which can be passed through by a pig, so that the piggable lines each pass through the distribution station.

35. The coating agent supply device according to claim 31, wherein
a) the common distribution station comprises a number n of inputs on the supply side for the piggable lines,
b) the common distribution station comprises a number m of outlets on the application side for the central channels to the transfer point,
c) at the distribution station the number n of inputs for the piggable lines is greater than the number m of outputs for the central channels, and/or
d) at the distribution station the number m of outlets for the central channels is two, three or four, and
e) the number n of inputs for the piggable lines at the distribution station is greater than four.

36. The coating agent supply device according to claim 23, wherein at least one pig sensor is arranged on the individual piggable lines in order to detect a pig in the piggable line.

37. The coating agent supply device according to claim 36, wherein the pig sensor is arranged at the pigging station at a distance from the pigging station of less than 50 cm.

38. The coating agent supply device according to claim 22, wherein
a) the coating agent storage container is replaceable, and
b) the coating agent storage container has a capacity of at least 10 liters, and
c) the number of coating agent storage containers is greater than two.

39. A coating installation for coating components with a coating agent, comprising:
a) a coating agent supply device according to claim 22, and
b) an application station, which is connected to the transfer point of the coating agent supply device and has at least one application device for applying the coating agent provided at the transfer point.

40. The coating installation according to claim 39, wherein
a) the transfer point of the coating agent supply device comprises a pig source module,
b) a pig target module is provided on the application device,
c) the pig source module of the transfer point is connected to the pig target module via a piggable line,
d) the piggable line between the transfer point and the application device has a line length which is greater than 1 m and less than 1 km.

41. The coating installation according to claim 40, wherein the pig source module is connected at the transfer point by several parallel piggable lines to the pig target module on the application device in order to be able to supply different coating agents.

42. The coating installation according to claim 39, wherein
a) the application device is an atomizer, and/or
b) the application device is guided by an application robot, and
c) the application station is arranged in a paint booth, and
d) the application station comprises several application devices, each of which is guided by an application robot.

43. An operating method for a coating installation according to claim 39, further comprising the following steps for at least one of the pig line systems:
a) Filling the piggable line of the coating agent supply device, the coating agent being pumped from the coating agent storage container through the circulation line of the pump circuit to the pig source module and flowing there into the piggable line, the pig being conveyed together with the coating agent in the piggable line from the pig source module to the pig target module,
b) circulating the coating agent in the large circuit formed by the pump circuit and the associated pig line system located in the paint mixing room, whereby the coating agent is circulated from the coating agent storage container via the circulation line of the pump circuit to the pig source module, through the piggable line to the pig target module, through the connecting line to the pig source module and through the circulation line back to the coating agent storage container,
c) stopping the circulation of the coating agent in the large circuit before starting a coating process,
d) taking of the coating agent from the piggable line at the distribution station,
e) forwarding the extracted coating agent from the distribution station through the central channel to the transfer point,
f) transferring the extracted coating agent from the transfer point to the application device of the application station,
g) application of the extracted coating agent through the application device,
h) returning the unapplied coating agent from the piggable line of the coating agent supply device via the pig source module and the circulation line of the pump circuit back into the coating agent storage container, and
i) rinsing the piggable line, the pig source module and/or the pig target module with pulsed air and/or rinsing agent.

44. The operating method according to claim 43, wherein the coating agent circulates in the pump circuit when the piggable line of the coating agent supply device is filled.

45. The operating method according to claim 43, further comprising the following steps for recycling coating agent:
a) Introducing compressed air at the pig target module into the piggable line, whereby the compressed air pushes the pig and the coating agent column located upstream of the pig in the piggable line to the pig source module,
b) pushing back the coating agent column at the pig source module from the piggable line into the circulation line of the pump circuit, and
c) pushing back the coating agent column from the circulation line of the pump circuit into the coating agent storage container.

46. The operating method according to claim 43, further comprising the following steps for rinsing the coating agent supply device:
a) Introduction of rinsing agent and/or pulsed air at the pig source module into the piggable line of the coating agent supply device,
b) passing the rinsing agent and/or the pulsed air from the pig source module through the piggable line to the pig target module,
c) forwarding the rinsing agent and/or the pulsed air at the pig target module through the connecting line to the pig source module, and
d) passing on the rinsing agent and/or the pulsed air at the pig source module into the circulation line of the pump circuit.
